(19) United States
(12) Patent Application Publication
(10) Pub. No.: US 2024/0147287 A1
(43) Pub. Date: May 2, 2024

(54) METHOD AND APPARATUS FOR TRANSCEIVING FLIGHT PATH OF TERMINAL IN MOBILE COMMUNICATION SYSTEM

(71) Applicant: Samsung Electronics Co., Ltd., Gyeonggi-do (KR)

(72) Inventors: Taeseop LEE, Gyeonggi-do (KR); Sangyeob JUNG, Gyeonggi-do (KR)

(21) Appl. No.: 18/499,459

(22) Filed: Nov. 1, 2023

(30) Foreign Application Priority Data
Nov. 1, 2022 (KR) 10-2022-0144000

(51) Int. Cl. H04W 24/10; H04B 17/27

(52) U.S. Cl. CPC H04W 24/10; H04B 17/27

(57) ABSTRACT

The disclosure relates to a fifth generation (5G) or sixth generation (6G) communication system for supporting a higher data transmission rate. A method performed by a terminal includes transmitting, to a base station, a first message including first information indicating an update of flight path information, receiving, from the base station, a second message requesting a flight path report, the second message including second information configuring at least one of a number of waypoints for the flight path report, a distance parameter for the flight path report, or a time parameter for the flight path report, generating the flight path report based on the second information, and transmitting, to the base station, a third message including the flight path report.

### CROSS-REFERENCE TO RELATED APPLICATION(S)

This application is based on and claims priority under 35 U.S.C. § 119 to Korean Patent Application No. 10-2022-0144000, filed on Nov. 1, 2022, in the Korean Intellectual Property Office, the disclosure of which is incorporated herein by reference in its entirety.

### BACKGROUND

### 1. Field

The disclosure relates generally to a wireless communication system, and more particularly, to a method and device for a terminal and a base station in the wireless communication system to efficiently transmit and receive a flight path plan of the terminal.

### 2. Description of Related Art

Fifth generation (5G) mobile communication technologies define broad frequency bands such that high transmission rates and new services are possible and can be implemented not only in Sub 6 gigahertz (GHz) bands such as 3.5 GHz, but also in Above 6 GHz bands referred to as millimeter wave (mmWave) bands including 28 GHz and 39 GHz. In addition, it has been considered to implement sixth generation (6G) mobile communication technologies (referred to as Beyond 5G systems) in terahertz (THz) bands (for example, 95 GHz to 3 THz bands) to accomplish transmission rates fifty times faster than 5G mobile communication technologies and ultra-low latencies one-tenth of 5G mobile communication technologies.

When the development of 5G mobile communication technologies began, to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of a bandwidth part (BWP), new channel coding methods such as a low density parity check (LDPC) code for large amount of data transmission and a polar code for highly reliable transmission of control information, L2 pre-processing, and network slicing for providing a dedicated network specialized to a specific service.

Discussions persist regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture or service based interface for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks. Thus, it is anticipated that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of THz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

A wireless communication system is evolving from its early voice-oriented service to a broadband wireless communication system which provides high-speed, high-quality packet data services according to communication standards such as high speed packet access (HSPA), long term evolution (LTE) or evolved universal terrestrial radio access (E-UTRA), LTE-advanced (A), LTE-Pro, high rate packet data (HRPD), ultra mobile broadband (UMB), and institute of electrical and electronics engineers (IEEE) 802.16e.

As an example of the broadband wireless communication system, the LTE system employs an orthogonal frequency division multiplexing (OFDM) scheme in a downlink (DL), and a single carrier frequency division multiple access (SC-FDMA) scheme in an uplink (UL). The UL indicates a radio link through which the terminal (or the UE) transmits data or a control signal to the base station (or the eNB, the gNB), and the DL indicates a radio link through which the base station transmits data or a control signal to the terminal. Such a multi-access scheme distinguishes data or control information of each user by assigning and operating time-frequency resources for carrying the data or the control information of each user not to overlap, that is, to establish orthogonality.

The 5G communication system, which should be able to freely reflect various requirements of users and service providers, should support a service for simultaneously satisfying various requirements. Such services include the aforementioned eMBB, mMTC, and URLLC.

The eMBB aims to provide a faster data rate than a data rate supported by existing LTE, LTE-A or LTE-Pro. For example, the eMBB in the 5G communication system should be able to provide a peak data rate of 20 gigabits per second (Gbps) in the DL and 10 Gbps in the UL in terms of one base station. The 5G communication system should provide the peak data rate and concurrently provide an increased user perceived data rate of the terminal. To satisfy these requirements, improvements of various transmission and reception technologies are required, including a further advanced MIMO transmission technology. In addition, while signals are transmitted using a maximum 20 megahertz (MHz) transmission bandwidth in a 2 GHz band used by the LTE, the 5G communication system uses a frequency bandwidth wider than 20 MHz in the frequency band of 3-6 GHz or 6 GHz or higher, thus satisfying the required data rate in the 5G communication system.

The 5G communication system is considering the mMTC to support application services such as IoT. The mMTC requires large-scale terminal access support in a cell, terminal coverage enhancement, improved battery time, and terminal cost reduction to efficiently provide the IoT. The IoT is attached to various sensors and devices to provide communication functions and accordingly should be able to support a large number of terminals (e.g., 1,000,000 terminals/km\hat{ }2) in the cell. In addition, the terminal supporting the mMTC is highly likely to be located in a shaded area not covered by the cell such as a basement of building due to its service characteristics, and thus may require wider coverage than other services provided by the 5G communication system. A terminal supporting the mMTC should be configured with a low-priced terminal and may require a long battery lifetime such as 10-15 years since it is difficult to frequently replace the battery of the terminal.

The URLLC is a cellular-based wireless communication service used for mission-critical purposes and may be used for robot or machinery remote control, industrial automation, unmanaged aerial vehicle, remote health care, emergency alert, or the like. Thus, the communication provided by the URLLC should provide very low latency (ultra-low latency) and very high reliability (ultra-high reliability). For example, a service supporting the URLLC should meet air interface latency less than 0.5 milliseconds (ms) and require a packet error rate below 10\hat{ }-5. Hence, for the service supporting the URLLC, the 5G system should provide a transmit time interval (TTI) less than other services, and concurrently require design issues for allocating a wide resource in the frequency band to obtain communication link reliability.

The eMBB, URLLC, and mMTC may be multiplexed and transmitted in one system. To satisfy the different requirements of the respective services, different transmission and reception schemes and transmission and reception parameters may be used between the services. Notably, the aforementioned mMTC, the URLLC, and the URLLC 5G are examples of the different service types, and the service type herein is not limited to those examples.

Conventionally, there are deficiencies in the flight path plan reported by terminals in the wireless communication system.

As such, there is a need in the art for a method and apparatus in which a terminal may efficiently report its flight path plan, and the base station and core network may efficiently obtain the flight path of the terminal.

### SUMMARY

The disclosure has been made to address at least the above-mentioned problems and/or disadvantages and to provide at least the advantages described below.

Accordingly, an aspect of the disclosure is to provide an improved method for a terminal to efficiently report its flight path plan in a mobile communication system and for a base station and core network to obtain the terminal's flight path.

In accordance with an aspect of the disclosure, a method performed by a terminal in a wireless communication system includes transmitting, to a base station, a first message including first information indicating an update of flight path information, receiving, from the base station, a second message requesting a flight path report, the second message including second information configuring at least one of a number of waypoints for the flight path report, a distance parameter for the flight path report, or a time parameter for the flight path report, generating the flight path report based on the second information, and transmitting, to the base station, a third message including the flight path report.

In accordance with an aspect of the disclosure, a method performed by a base station in a wireless communication system includes receiving, from a terminal, a first message including first information indicating an update of flight path information, transmitting, to the terminal, a second message requesting a flight path report, the second message including second information configuring at least one of a number of waypoints for the flight path report, a distance parameter for the flight path report, or a time parameter for the flight path report, and receiving, from the terminal, a third message including the flight path report based on the second information.

In accordance with an aspect of the disclosure, a terminal in a wireless communication system includes a transceiver, and a controller coupled with the transceiver and configured to transmit, to a base station, a first message including first information indicating an update of flight path information, receive, from the base station, a second message requesting a flight path report, the second message including second information configuring at least one of a number of waypoints for the flight path report, a distance parameter for the flight path report, or a time parameter for the flight path report, generate the flight path report based on the second information, and transmit, to the base station, a third message including the flight path report.

In accordance with an aspect of the disclosure, a base station in a wireless communication system includes a transceiver, and a controller coupled with the transceiver and configured to receive, from a terminal, a first message including first information indicating an update of flight path information, transmit, to the terminal, a second message requesting a flight path report, the second message including second information configuring at least one of a number of waypoints for the flight path report, a distance parameter for the flight path report, or a time parameter for the flight path report, and receive, from the terminal, a third message including the flight path report based on the second information.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates the structure of a next-generation mobile communication system according to an embodiment;

FIG. 2 illustrates a UE's flight path reporting configurations and reporting operations in a next-generation mobile communication system according to an embodiment;

FIG. 3 illustrates a UE's flight path update function in a next-generation mobile communication system according to an embodiment;

FIG. 4 illustrates a process in which a UE reports to a base station whether a flight path is updated and the base station requests an updated path in a next-generation mobile communication system according to an embodiment;

FIG. 5 illustrates a process of reporting the updated flight path of a UE to a base station in a next-generation mobile communication system according to an embodiment;

FIG. 6 illustrates a process of periodically reporting the updated flight path of a UE to a base station in a next-generation mobile communication system according to an embodiment;

FIG. 7 illustrates a method for reporting the updated flight path of a UE in a next-generation mobile communication system according to an embodiment;

FIG. 8 is a block diagram illustrating the structure of a UE according to an embodiment; and

FIG. 9 is a block diagram illustrating the structure of a base station according to an embodiment.

### DETAILED DESCRIPTION

The following description with reference to the accompanying drawings is provided to assist in a comprehensive understanding of embodiments of the present disclosure. Accordingly, those of ordinary skill in the art will recognize that various changes and modifications of the embodiments described herein can be made without departing from the scope and spirit of the present disclosure. Descriptions of well-known functions and constructions may be omitted for the sake of clarity and conciseness.

Technical contents well known in the technical field to which the present disclosure pertains and which are not directly related to the present disclosure will be omitted in the specification to more concisely explain the subject matter of the present disclosure.

For the same reason, some components in the accompanying drawings are exaggerated, omitted, or schematically illustrated, and a size of each component does not entirely reflect an actual size. The same reference number is given to the same or corresponding element in each drawing.

The same reference numeral refers to the same element throughout the specification.

An element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The term ‘˜unit’ as used in the present embodiment indicates software or a hardware component such as a field programmable gate array (FPGA) or an application-specific integrated circuit (ASIC), and unit performs specific roles. However, unit is not limited to software or hardware and may be configured to reside on an addressable storage medium and configured to reproduce on one or more processors. Accordingly, unit may include components such as software components, object-oriented software components, class components and task components, processes, functions, attributes, procedures, sub-routines, segments of program code, drivers, firmware, microcode, circuitry, data, databases, data structures, tables, arrays, and variables. The functionalities provided in the components and unit may be combined to fewer components and units or may be further separated into additional components and units. The components and units may be implemented to reproduce one or more central processing units (CPUs) within a device or a security multimedia card. A unit may include one or more processors.

Terms for identifying access nodes and for indicating network entities, messages, interfaces between network entities, and various identification information used in the description are illustrated only for convenience of description. Accordingly, the present disclosure is not limited to the terms to be described, and other terms having the same technical meaning may be used.

Terms and names defined in a 3rd generation partnership project (3GPP) LTE standard may be used for the convenience of description. However, the present disclosure is not limited by these terms and names, and may be applied in the same manner to systems conforming to other standards.

A base station, which is an entity for performing resource allocation of a terminal, may be at least one of a next generation node B (gNB), an evolved node B (eNB), a node B, a radio access unit, a base station controller, or a node on the network. The eNB may be interchangeably used with the gNB in the present disclosure for ease of explanation. That is, the base station described as the eNB may also indicate the gNB. A terminal may include a user equipment (UE), a mobile station (MS), a cellular phone, a smartphone, a computer, or a multimedia system for executing a communication function. The present disclosure is not limited to those examples.

In particular, the present disclosure may be applied to the 3GPP NR standard and intelligent services based on the 5G communication and IoT related technologies (e.g., smart home, smart building, smart city, smart car or connected car, health care, digital education, retail, security and safety services, etc.). A terminal may indicate other wireless communication devices as well as narrowband (NB)-IoT devices and sensors.

Embodiments of the present disclosure may be explained with an LTE, LTE-A, LTE Pro, 5G (or NR), or 6G system as an example, but may also be applied to other communication systems having similar technical backgrounds or channel forms without significantly departing from the range of the present disclosure based on determination of those skilled in the art.

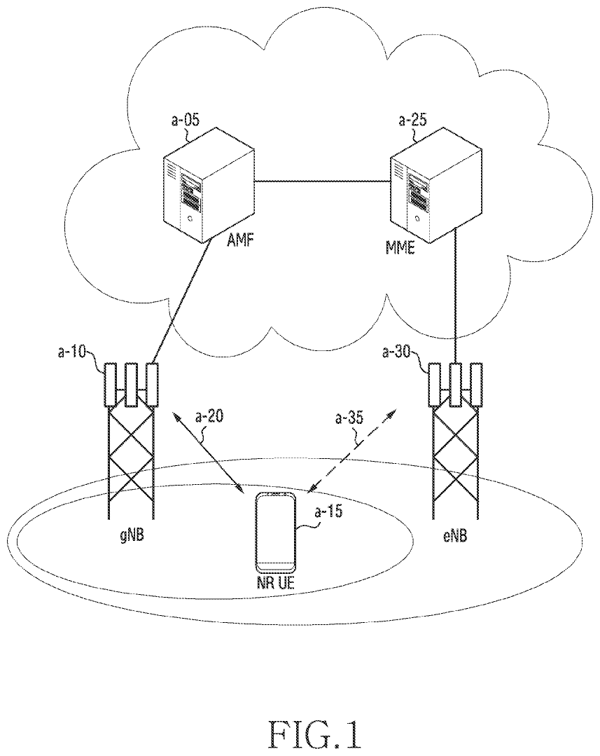

FIG. 1 illustrates the structure of a next-generation mobile communication system according to an embodiment.

Referring to FIG. 1, the radio access network of a next-generation mobile communication system (NR) is composed of a next-generation base station (next generation Node B, hereinafter referred to as gNB) a-10 and an access and mobility management function (AMF) a-05. An NR UE (or UE) a-15 accesses an external network through the gNB a-10 and the AMF a-05.

In FIG. 1, the gNB corresponds to an eNB of a general LTE system, is connected to the NR UE through a radio channel, and may provide a service superior to that of the existing Node B (a-20). Since all user traffic is serviced through the shared channel in the next-generation mobile communication system, a device for scheduling by collecting state information such as a buffer state of the UEs, an available transmission power state, a channel state, etc. may be required, for which the gNB a-10 is responsible. One gNB usually controls multiple cells. The next-generation mobile communication system may have a bandwidth greater than or equal to the existing maximum bandwidth to implement ultra-high-speed data transmission compared with the general LTE, and additional beamforming technology may be additionally applied by using OFDM as a radio access technology. In addition, an adaptive modulation & coding (AMC) scheme for determining a modulation scheme and a channel coding rate according to the channel state of the UE is applied. The AMF a-05 performs functions such as mobility support, bearer configuration, quality of service (QoS) configuration, and the like. The AMF a-05 controls various control functions as well as a mobility management function for the UE, and is connected to a plurality of base stations. In addition, the next-generation mobile communication system may be linked with the existing LTE system, and the AMF a-05 is connected to the mobility management entity (MME) a-25 through a network interface. The MME a-25 is connected to the LTE base station eNB a-30. The UE that supports LTE-NR dual connectivity a-35 may transmit and receive data while maintaining connections to not only the gNB but also the eNB a-30.

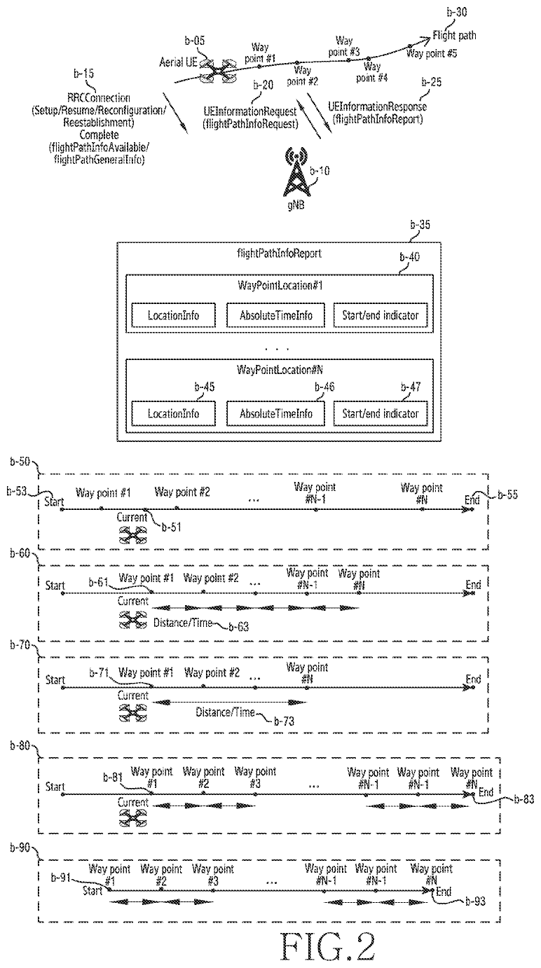

FIG. 2 illustrates a UE's flight path reporting configurations and reporting operations in a next-generation mobile communication system according to an embodiment. Hereinafter, the UE may refer to an aerial UE capable of air transportation but is not limited thereto.

The next-generation mobile communication system may be used as communication for air transportation such as an uncrewed/unmanned aerial vehicle (UAV) and uncrewed/unmanned aerial mobility (UAM). To this end, assuming the aerial UE, a function to support communication services for the aerial UE should be introduced in the next-generation mobile communication system.

The UAV/UAM may move along a predetermined flight path b-30. Accordingly, if the base station b-10 knows the determined path, the information may be used to support mobility (e.g., handover) of the aerial UE b-05. To this end, the aerial UE b-05 may inform the base station b-10 that the aerial UE has the flight path information (i.e., flightPathInfoAvailable) by using predetermined RRC messages, for example, RRCConnectionSetupComplete, RRCConnectionResumeComplete, RRCConnectionReestablishmentComplete, RRCConnectionReconfigurationComplete, etc. messages b-15. The base station b-10 may request the flight path information from the aerial UE b-05 through a predetermined RRC message, for example, a UEInformationRequest message b-20, and the aerial UE b-05, which has received the request, may report the flight path information (FlightPathInfoReportIE) to the base station b-10 through a predetermined RRC message, for example, the UEInformationResponse message b-25. The flight path information b-35 may be configured in the form of a list of each waypoint (location point) information b-40 through which the aerial UE (b-05) must pass. In this case, each waypoint information b-40 may again be composed of location information b-45 of each waypoint and expected time information b-46 when passing that point. If a specific waypoint is the flight path start/end point of the aerial UE b-05, an indicator b-47 to indicate that the corresponding waypoint is the flight path start/end point may be additionally included in the waypoint information b-40. The flight path start/end point may include at least one of the start point of the flight path and the end point of the flight path.

When the base station b-10 requests the flight path information from the aerial UE b-05 through the UEInformationRequest message b-20, the base station b-10 may indicate to the aerial UE b-05 the maximum number of waypoints that the aerial UE b-05 may report through the UEInformationResponse message b-25, whether to include time information b-46 in each waypoint information b-40, whether to include the flight path start/end indicator b-47 in each waypoint information b-40, and the like.

The aerial UE b-05 may report flight path information to the base station b-10 through the UEInformationResponse message b-25. The aerial UE b-05 may arbitrarily report information on N waypoints to the base station b-10 within the maximum number of waypoints configured by the base station b-10 through the UEInformationRequest message b-20, the maximum number of waypoints defined in the standard, or the corresponding number (N) of the waypoint information if the base station configures the number of waypoints to report to N. The aerial UE b-05 may include time information b-46 only when the base station b-10 indicates the waypoint information b-40 to include time information through the UEInformationRequest message b-20, or may include time information without configurations of the base station. The aerial UE b-05 may include flight path start/end indicator b-47 only when the base station b-10 indicates the waypoint information b-40 to include the flight path start/end indicator b-47 through the UEInformationRequest message b-20, or may include the flight path start/end indicator b-47 without configurations of the base station.

When the aerial UE b-05 reports the flight path through the UEInformationResponse message b-25, the following methods may be considered for selecting the N waypoints to be reported on the entire flight path.

As a first option (b-50), the aerial UE b-05 may arbitrarily select and report N waypoints among the waypoints from the start point b-53 to the end point b-55 of the flight path.

As a second option (b-60), the aerial UE b-05 may select and report N waypoints at the same distance/time interval b-63 from the location b-61 at the time of flight path reporting. The distance/time interval may include at least one of a distance interval and a time interval. For this purpose, the base station b-10 may additionally include the distance/time interval b-63 (e.g., {distance: 1 meter} or {time: 1 minute}) information to be used in waypoint selection in the message b-20. Through this method, the base station b-10 may efficiently receive practical and necessary flight path information (i.e., a path within a predetermined range based on the current aerial UE's location, not the entire flight path) to optimize mobility support of the aerial UE b-05, such as handover timing and handover target cell/base station optimization when the aerial UE moves out of the base station coverage.

As a third option (b-70), the aerial UE b-05 may select and report N waypoints evenly distributed within a specific distance/time range b-73 from the location b-71 at the time of flight path reporting. For this purpose, the base station b-10 may additionally include the distance/time range b-63 (e.g., {distance: 100 meters} or {time: 10 minutes}) information to be used in waypoint selection in the message b-20. The distance/time range may include at least one of a distance range and a time range. Through this method, the base station b-10 may efficiently receive practical and necessary flight path information (i.e., a path within a predetermined range based on the current aerial UE's location, not the entire flight path) to optimize mobility support of the aerial UE b-05, such as handover timing and handover target cell optimization when the aerial UE moves out of the base station coverage.

As a fourth option (b-80), the aerial UE b-05 may select and report N waypoints evenly distributed based on distance or time on the path from the location at the time of flight path reporting to the end point of the flight path b-83. In this case, the location at the time of path reporting b-81 and the end point of the flight path b-83 may be specified in the specifications to be included in the N waypoints. For this purpose, the base station b-10 may additionally include information to indicate whether waypoints should be distributed evenly based on distance or time information in the message b-20.

As a fifth option (b-90), the aerial UE b-05 may select and report N waypoints evenly distributed based on distance or time on the path from the start point b-91 to the end point b-93. In this case, the start point b-91 to the end point b-93 of the flight path may be specified in the specifications to be included in the N waypoints. For this purpose, the base station b-10 may additionally include information to indicate whether waypoints should be distributed evenly based on distance or time information in the message b-20.

In order for the base station b-10 to specifically configure the flight path reporting of the aerial UE b-05 as described above, comprehensive information on the entire flight path may be provided to the base station prior to flight path reporting configuration (b-20). For this purpose, the aerial UE b-05 may transmit comprehensive information (e.g., flight path starting point, flight path ending point, estimated flight time, average flight speed, average flight altitude, etc.) on the flight path to the base station b-10 through a predetermined RRC message (e.g., RRCConnectionSetupComplete, RRCConnectionResumeComplete, RRCConnectionReestablishmentComplete, RRCConnectionReconfigurationComplete, or UEAssistanceInformation messages, etc.) before the flight path reporting configuration b-20.

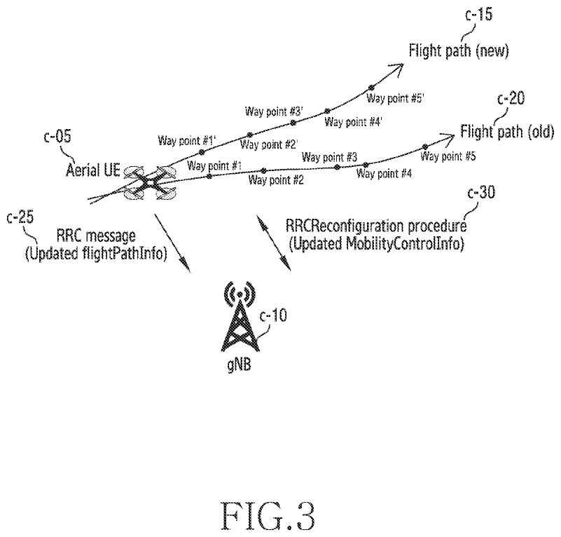

FIG. 3 illustrates a UE's flight path update function in a next-generation mobile communication system according to an embodiment.

In FIG. 3, after the aerial UE c-05 reports the flight path c-20 to the base station (c-10) through the process of FIG. 2, the flight path of the aerial UE c-05 may be changed to a new path c-15. These flight path changes may be made intentionally by UAV/UAM users and servers, or may be made by external factors (e.g., weather, traffic congestion, etc.). When the flight path is changed, the aerial UE c-05 may report updated/changed flightPathInfo (i.e., changed flight path information) to the base station c-10 through a predetermined RRC message c-25. In this case, the updated flightPathInfo may include all waypoint information on the new flight path c-15 or may only partially include changed waypoint information compared to the previously reported flight path c-20.

When receiving the report of changed flight path information c-25 from the aerial UE c-05, the base station c-10 may optimize mobility support of the aerial UE c-05 based on the changed flight path information by determining in advance the cell information (frequency, bandwidth, etc.) operated by at least one base station located at the waypoint where the aerial UE c-05 will move according to the changed flight path, and by reconfiguring the measurement and (conditional) handover of the aerial UE c-05 through the RRC reconfiguration procedure c-30 based on the cell information, or performing in advance the signaling operation between base stations required for handover (HO) of the aerial UE c-05.

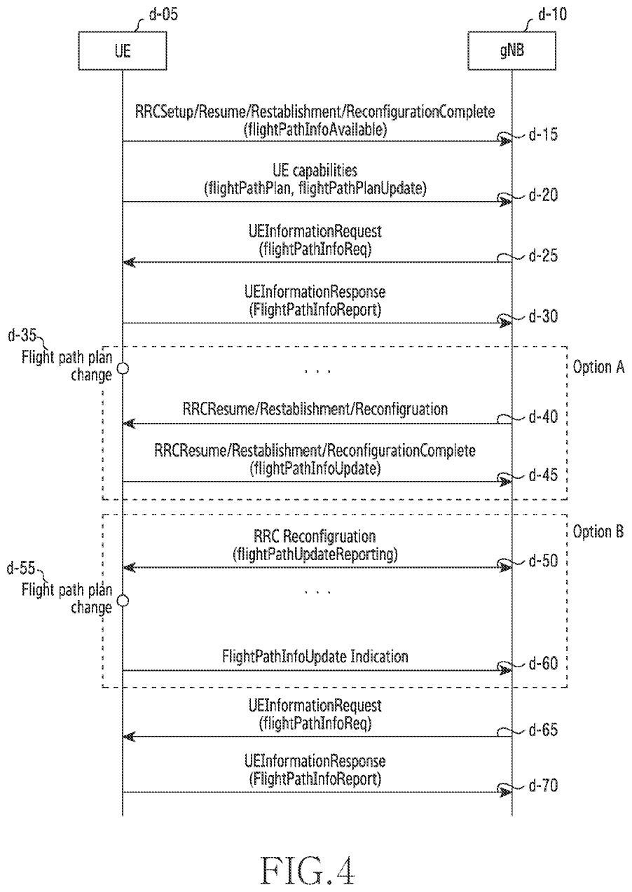

FIG. 4 illustrates a process in which a UE reports to a base station whether a flight path is updated and the base station requests an updated path in a next-generation mobile communication system according to an embodiment.

In FIG. 4, when a change occurs in the previously reported flight path, the UE d-05 may report to the base station d-10 whether the flight path is updated. Afterwards, the base station d-10 may indicate to the UE d-05 to report the updated flight path.

In step d-15, the UE d-05 may report to the base station d-10 that the UE has flight path information through the RRCSetupComplete/RRCResumeComplete/RRCReestablishmentComplete/RRRCReconfigurationComplete message, which may include at least one of the RRCSetupComplete message, the RRCResumeComplete message, the RRCReestablishmentComplete message, and the RRCReconfigurationComplete message. A 1-bit indicator such as flightPathInfoAvailable may be included in the messages by the UE d-05 to report that the flight path information is available. To help the base station d-10 to indicate a flight path reporting, the above messages may include comprehensive information (e.g., flight path starting point, flight path ending point, estimated flight time, average flight speed, average flight altitude, etc.) on the flight path of the corresponding UE d-05.

In step d-20, the UE d-05 may report its capability information to the base station d-10. In this case, the capability information may indicate whether the UE supports flight path information reporting and flight path information update, and whether the UE d-05 supports each method of selecting the N waypoints to be reported on the entire flight path described in FIG. 2.

In step d-25, the base station d-10 may request that the UE d-05 report the flight path through the UEInformationRequest message. In this case, the maximum number of waypoints that the UE d-05 may report and whether to include time information in each waypoint information may be indicated together through the UEInformationResponse message (d-30). In addition, the distance/time interval b-63, distance/time range b-73, distance/time reference indicator (information to indicate whether waypoints should be distributed evenly based on distance or time in the message), etc. may be included in UEInformationResponse message (d-30) and indicated together according to the method of selecting N waypoints to be reported on the entire flight path described in FIG. 2.

In step d-30, the UE d-05 may report flight path information to the base station d-10 through a UEInformationResponse message. The UE d-05 may arbitrarily report information on N waypoints to the base station d-10 within the range of the maximum number of waypoints configured by the base station d-10 through the UEInformationRequest message d-25 or the maximum number of waypoints predefined in the specification. When the base station configures the number of waypoints to report, the UE may report the corresponding number of waypoint information to the base station. The UE d-05 may include time information only when the base station d-10 indicates the waypoint information to include time information through the UEInformationRequest message d-25, or may include time information without configurations of the base station. The aerial UE b-05 may include the corresponding indicator b-47 only when the base station b-10 indicates the waypoint information b-40 to include the flight path start/end indicator b-47 through the UEInformationRequest message b-20 or may include the indicator b-47 without configurations of the base station.

The following are options as a method for the UE d-05 to report whether the flight path is updated to the base station d-10.

As a first option (Option A), in step d-35, the flight path of the UE d-05 changes and the UE d-05 may detect the change in the flight path. Thereafter, in step d-40, when at least one of the RRC resume procedure, RRC reestablishment procedure, and RRC reconfiguration procedure occurs, the base station d-10 may transmit at least one of the RRCResume message, RRCReestablishment message, and RRCReconfiguration to the UE d-05. In step d-45, the UE d-05 may include an indicator (e.g., flightPathInfoUpdate) indicating whether to update the flight path when the flight path update condition is satisfied while transmitting the RRRCesumeComplete/RRCReestablishmentComplete/RRRCeconfigurationComplete message to the base station d-10. For example, the indicator may be 1 bit.

As a second option (Option B), in step d-50, the base station d-10 may configure the UE d-05 to report whether the flight path is updated when the flight path changes through the RRC Reconfiguration procedure. In this case, to prevent the base station load from increasing due to the UE's flight path update reporting occurring too frequently, the base station d-10 may also configure a Prohibit timer value, which refers to the minimum time interval between the path update reporting. When the Prohibit timer is configured, the UE starts the Prohibit timer when reporting a flight path update, and a new path update reporting cannot be performed until the Prohibit timer expires.

In step d-55, the flight path of the UE d-05 changes and the UE d-05 may detect the change. In step d-60, the UE d-05 may report to the base station d-10 whether the flight path is updated if the flight path update conditions are satisfied. For this purpose, the UE d-05 may transmit an indicator indicating whether the flight path is updated (e.g., flightPathInfoUpdate) in a predetermined RRC message (e.g., UEAssistanceInformation), or medium access control (MAC) control element (CE) to report flight path updates to the base station d-10. For example, the indicator may be 1 bit.

When Option A is used, the UE d-05 may reduce the signaling load by reporting whether the flight path is updated through the RRCResumeComplete/RRCReestablishmentComplete/RRCReconfigurationComplete message instead of transmitting a separate RRC message or MAC CE to report whether the flight path is updated. However, the UE d-05 may report the flight path update only when the UE receives the RRCResume/RRCReestablishment/RRCReconfiguration message from the base station d-10, by which there may be a time delay from the time the flight path is actually changed (d-35) to the time the flight path update is reported (d-45).

When Option B is used, the UE d-05 may transmit a separate RRC message or MAC CE to report whether the flight path is updated to the base station d-10. In this case, the UE d-05 may report whether the flight path is updated to the base station d-10 immediately after detecting the flight path change.

In step d-65, the base station d-10, which identified the flight path update of the UE d-05 through the above process, may request the UE d-05 to report the changed flight path through a predetermined RRC message. In this case, the base station d-10 may configure the UE d-05 to newly report all waypoint information for the changed flight path regardless of the flight path d-30 previously reported by the UE d-05, or to partially report only the changed waypoint information based on the previously reported flight path d-30.

In step d-70, the UE d-05 may report the changed flight path information through a predetermined RRC message according to the base station request in step d-65. The UE d-05 may newly report all the waypoint information for the changed flight path or only partially report the changed waypoint information compared to the previously reported flight path d-30. For example, when the previously reported flight path consists of 5 waypoints (w1, w2, w3, w4, w5), two waypoints (w4, w5) among the five waypoints may be changed to waypoints (w4′, w5′) and a new waypoint (w6) may be added due to the changes in the flight path. In this case, the UE d-05 may report information on all waypoints (w1, w2, w3, w4′, w5′, w6) comprised in the changed path, or partially report only the changed waypoints (w4′, w5′, w6). In addition, even if only part of the location and time information for a specific waypoint is changed, all of the location and time information for that waypoint may be newly reported, or only the changed information among the location or time information may be partially reported.

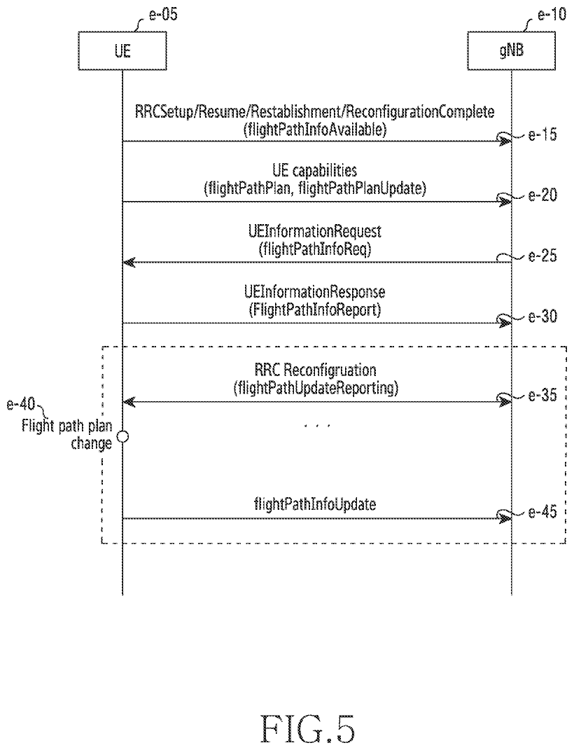

FIG. 5 illustrates a process of reporting the updated flight path of a UE to a base station in a next-generation mobile communication system according to an embodiment.

In step e-15, the UE e-05 may report to the base station e-10 that the UE has flight path information through the RRCSetupComplete/RRCResumeComplete/RRCReestablishmentComplete/RRCReconfigurationComplete message. For this purpose, an indicator such as flightPathInfoAvailable may be included in the above messages and may be 1 bit. To help the base station d-10 indicate a flight path reporting, the above messages may include comprehensive information (e.g., flight path starting point, flight path ending point, estimated flight time, average flight speed, average flight altitude, etc.) on the flight path of the corresponding UE d-05.

In step e-20, the UE e-05 may report its capability information to the base station e-10. In this case, the capability information indicates whether the UE e-05 supports flight path information reporting and flight path information update, and whether the UE d-05 supports each method of selecting the N waypoints to be reported on the entire flight path described in FIG. 2.

In step e-25, the base station e-10 may request that the UE e-05 report the flight path through the UEInformationRequest message. In this case, the maximum number of waypoints that the UE e-05 may report and whether to include time information in each waypoint information may be indicated together through the UEInformationResponse message (e-30). The distance/time interval b-63, distance/time range b-73, distance/time reference indicator (information to indicate whether waypoints should be distributed evenly based on distance or time in the message), etc. may be indicated together according to the method of selecting N waypoints to be reported on the entire flight path described in FIG. 2.

In step e-30, the UE e-05 may report flight path information to the base station e-10 through, a UEInformationResponse message. The UE e-05 may arbitrarily report information on N waypoints to the base station e-10 within the range of the maximum number of waypoints configured by the base station e-10 through the UEInformationRequest message e-25 or the maximum number of waypoints predefined in the specification. When the base station configures the number of waypoints to report, the UE may report the corresponding number of waypoint information to the base station. In addition, the UE e-05 may include time information only when the base station e-10 indicates the waypoint information to include time information through the UEInformationRequest message e-25, or may include time information without configurations of the base station. The aerial UE b-05 may include the corresponding indicator b-47 only when the base station b-10 indicates the waypoint information b-40 to include the flight path start/end indicator b-47 through the UEInformationRequest message b-20 or may include the indicator b-47 without configurations of the base station.

In step e-35, the base station e-10 may configure the UE e-05 to report whether the flight path is updated when the flight path changes through the RRC Reconfiguration procedure. To prevent the base station load from increasing due to the UE's flight path update reporting occurring too frequently, the base station e-10 may also configure a Prohibit timer value, which refers to the minimum time interval between the path update reporting. When the Prohibit timer is configured, the UE starts the Prohibit timer when reporting a flight path update, and a new path update reporting cannot be performed until the Prohibit timer expires. The base station e-10 may configure the UE 3-05 to newly report all waypoint information for the changed flight path regardless of the flight path e-30 previously reported by the UE e-05, or to partially report only the changed waypoint information based on the previously reported flight path e-30.

In step e-40, the flight path of the UE e-05 changes and the UE e-05 may detect the change.

In step e-45, when the flight path update conditions are satisfied, the UE e-05 may report the updated flight path information to the base station e-10 through a predetermined RRC message. In this case, according to the base station request in step e-35, the UE e-05 may newly report all the waypoint information for the changed flight path or only partially report the changed waypoint information compared to the previously reported flight path e-30. For example, when the previously reported flight path consists of 5 waypoints (w1, w2, w3, w4, w5), two waypoints (w4, w5) among the five waypoints may be changed to waypoints (w4′, w5′) and a new waypoint (w6) may be added due to the changes in the flight path. In this case, the UE may report information on all waypoints (w1, w2, w3, w4′, w5′, w6) that is comprised in the changed path, or partially report only the changed waypoints (w4′, w5′, w6). Even if only part of the location and time information for a specific waypoint is changed, all of the location and time information for that waypoint may be newly reported, or only the changed information among the location or time information may be partially reported.

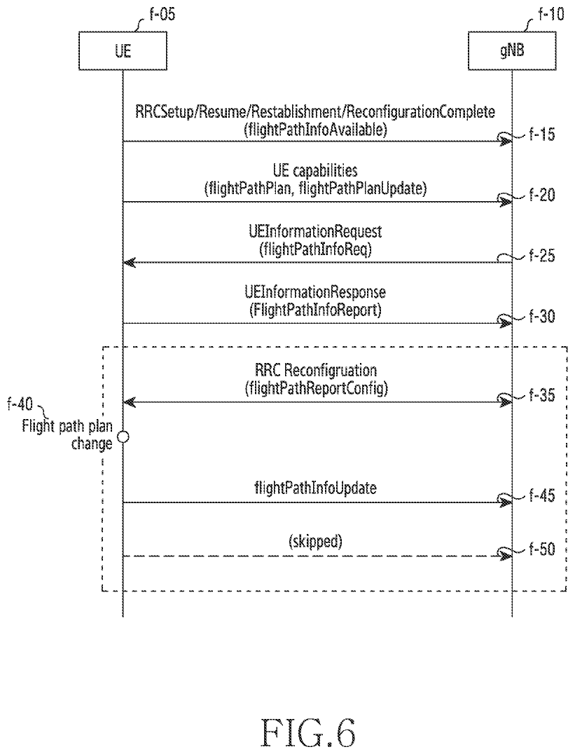

FIG. 6 illustrates a process of periodically reporting the updated flight path of a UE to a base station in a next-generation mobile communication system according to an embodiment.

In step f-15, the UE f-05 may report to the base station f-10 that the UE has flight path information through the RRCSetupComplete/RRCResumeComplete/RRCReestablishmentComplete/RRCReconfigurationComplete message. In order to report that the UE has flight path information, an indicator such as flightPathInfoAvailable may be included in the above messages and may be 1 bit. To help the base station d-10 indicate a flight path reporting, the above messages may include comprehensive information (e.g., flight path starting point, flight path ending point, estimated flight time, average flight speed, average flight altitude, etc.) on the flight path of the corresponding UE d-05.

In step f-20, the UE f-05 may report its capability information to the base station f-10. The capability information indicates whether the UE f-05 supports flight path information reporting and flight path information update, and whether the UE d-05 supports each method of selecting the N waypoints to be reported on the entire flight path described in FIG. 2.

In step f-25, the base station f-10 may request that the UE f-05 report the flight path through the UEInformationRequest message. The maximum number of waypoints that the UE f-05 may report and whether to include time information in each waypoint information may be indicated together through the UEInformationResponse message (f-30). In addition, the distance/time interval b-63, distance/time range b-73, distance/time reference indicator (information to indicate whether waypoints should be distributed evenly based on distance or time in the message), etc. may be indicated together according to the method of selecting N waypoints to be reported on the entire flight path described in FIG. 2.

In step f-30, the UE f-05 may report flight path information to the base station f-10 through a UEInformationResponse message. The UE f-05 may arbitrarily report information on N waypoints to the base station f-10 within the range of the maximum number of waypoints configured by the base station f-10 through the UEInformationRequest message f-25 or the maximum number of waypoints predefined in the specification. When the base station configures the number of waypoints to report, the UE may report the corresponding number of waypoint information to the base station. The UE f-05 may include time information only when the base station f-10 indicates the waypoint information to include time information through the UEInformationRequest message f-25 or may include time information without configurations of the base station. The aerial UE b-05 may include the corresponding indicator b-47 only when the base station b-10 indicates the waypoint information b-40 to include the flight path start/end indicator b-47 through the UEInformationRequest message b-20 or may include the indicator b-47 without configurations of the base station.

In step f-35, the base station f-10 may configure the UE e-05 to report the flight path periodically through the RRC Reconfiguration procedure. For this purpose, the base station f-10 may configure the flight path reporting period or time interval. The base station f-10 may configure the UE f-05 to newly report all waypoint information for the changed flight path regardless of the flight path previously reported by the UE f-05, or to partially report only the changed waypoint information based on the previously reported flight path.

In step f-40, the flight path of the UE f-05 changes and the UE f-05 may detect the change.

In step f-45, when the flight path report timing is determined according to the flight path report configurations by the base station in step f-35 and the flight path update conditions are satisfied, the UE f-05 may report the updated flight path information to the base station f-10 through a predetermined RRC message. In this case, according to the request from the base station f-10 in step f-35, the UE f-05 may newly report all the waypoint information for the changed flight path or only partially report the changed waypoint information compared to the previously reported flight path. For example, when the previously reported flight path consists of 5 waypoints (w1, w2, w3, w4, w5), two waypoints (w4, w5) among the five waypoints may be changed to waypoints (w4′, w5′) and a new waypoint (w6) may be added due to the changes in the flight path. In this case, the UE f-05 may report information on all waypoints (w1, w2, w3, w4′, w5′, w6) that are comprised in the changed path, or partially report only the changed waypoints (w4′, w5′, w6). Even if only part of the location and time information for a specific waypoint is changed, all of the location and time information for that waypoint may be newly reported, or only the changed information among the location or time information may be partially reported.

When the flight path reporting time has been reached according to the flight path reporting configurations configured by the base station f-10 in step f-35, but the flight path update conditions are not satisfied, the UE f-05 may omit the flight path reporting at the corresponding time point (f-50).

The following operations that are commonly applicable to the flight path update operation described in FIGS. 3, 4, 5, and 6 are now disclosed.

Flight Path Update Conditions:

The UE's expected flight path may continue to change slightly depending on the flight situation. Accordingly, if the UE reports the updated flight path to the base station every time a change occurs in the flight path, unnecessary load may be generated. Even if the location information among the waypoint information remains the same, the time information on the time of passing the waypoint may continue to be slightly changed depending on the flight situation. If the UE continues to report the updated flight path to the base station every time a change occurs in the flight path, the load on the base station may increase significantly. However, if the changed information is not significantly different from the existing information, there may be no additional operations that the base station may perform to optimize mobility support (measurement and HO reset) for the corresponding UE.

Thus, the following options are disclosed as conditions (expressed as ‘flight path update conditions’ in the descriptions of FIGS. 4, 5, and 6) for determining whether the UE needs a flight path update.

As a first option, if any change occurs in the flight path previously reported by the UE, the UE may update the flight path. Specifically, the flight path update condition may be satisfied if, for a certain waypoint constituting the previously reported flight path, a change occurs in LocationInfo (location information), or a change occurs in TimeInfo (time information).

However, conditions for changing the time information may not be included. While configuring the UE to report an updated flight path, the base station may also indicate whether a change condition for time information may be included in the flight path update condition.

As a second option, if a change above a specified level occurs in the flight path previously reported by the UE, the UE may update the flight path. Specifically, the flight path update condition may be satisfied if any of the following conditions are satisfied for a certain waypoint constituting the previously reported flight path.

(1) LocationInfo Difference>LocationChangeThreshold

LocationInfo difference refers to an amount of change between previously reported location information and changed location information. and

LocationChangeThreshold refers to the threshold value configured by base station, such as a value in centimeters or meters.

(2) TimeInfo Difference>TimeChangeThreshold

TimeInfo difference refers to an amount of change between previously reported time information and changed time information, and

TimeChangeThreshold refers to the threshold value configured by base station, such as a value in milliseconds (msec), seconds (sec), minutes (min0, or hours.

However, conditions for changing the time information may not be included. While configuring the UE to report an updated flight path, the base station may also indicate whether a change condition for time information may be included in the flight path update condition.

As a third option, the base station may indicate to the UE to include the location uncertainty range when reporting the flight path. Afterwards, the UE may report the flight path by including the uncertainty range for the location information of each waypoint. For example, the ellipsoidPointWithAltitudeAndUncertaintyEllipsoid IE and the like defined in the specification may be used to report including the uncertainty range along with waypoint location information. If a path change that exceeds the uncertainty range occurs in the flight path previously reported by the UE, the UE may update the flight path. Specifically, the flight path update condition may be satisfied if, for a certain waypoint constituting the previously reported flight path, a Changed LocationInfo of a certain waypoint is outside the uncertainty range of the previous LocationInfo of the corresponding waypoint.

As a fourth option, if changes occur in a specified number of waypoints or more among the waypoints constituting the flight path previously reported by the UE, the UE may update the flight path. Specifically, the flight path update condition is satisfied when, for the waypoints constituting the previously reported flight path, the # of changed waypoints>WaypointChangeThreshold

The # of changed waypoints refers to the number of waypoints that have changed among the waypoints constituting the previously reported flight path. The first option, second option, third option, etc. may be used together as a condition to determine whether a change has occurred at each waypoint.

The WaypointChangeThreshold refers to the threshold value configured by base station.

As a fifth option, the base station may separately indicate the UE about ‘some waypoints’ that the base station is interested in among the waypoints constituting the flight path previously reported by the UE. In this case, a method of indicating ‘N’ number of waypoints in the order in the waypoint list previously reported by the UE, a method of indicating waypoints within the ‘X’ meter from the current location of the UE (or the location at the time when the flight path was previously reported), and a method of indicating specific waypoints in a waypoint list previously reported by the UE (for example, a method of indicating specific waypoints through the order index of waypoints in the list), may be considered as the method for the base station to indicate the ‘some waypoints’. The UE may update the flight path if a change in waypoint information occurs in ‘some waypoints’ indicated by the base station through the above method among the waypoints constituting the previously reported flight path.

Specifically, if a change occurs in LocationInfo (location information) or in TimeInfo (time information), the flight path update condition is satisfied.

Alternatively, the flight path update condition may be satisfied if, for ‘some waypoints’ indicated by the base station among the waypoints constituting the previously reported flight path, the # of changed waypoints>WaypointChangeThreshold.

The # of changed waypoints refers to the number of waypoints that have changed for ‘some waypoints’ indicated by the base station among the waypoints constituting the previously reported flight path. The first option, second option, third option, etc. may be used together as a condition to determine whether a change has occurred at each waypoint.

The WaypointChangeThreshold refers to the threshold value configured by base station.

As a sixth option, the UE may update the flight path when the next waypoint is different from the previously reported waypoint on the flight path. For example, the previously reported flight path consisted of waypoint (w1, w2, w3, w4), but the new flight path may be composed of waypoints (w1, w2, w3′, w4′) by changing waypoint (w3, w4). In this case, after the UE passes waypoint w2, the next waypoint w3 is a waypoint that has been changed to waypoint w3′, so the path change update condition is satisfied and the UE may report the changed flight path. In this case, the first option, second option, third option, etc. may be used together as conditions to determine whether a change has occurred at each waypoint.

As a seventh option, the UE may update the flight path when the number of remaining waypoints (that is, the total number of previously reported waypoints—the number of waypoints the UE has already passed) among the waypoints constituting the previously reported flight path decreases below a predetermined number. Specifically, the flight path update condition is satisfied when the # of remaining waypoints>WaypointUpdateThreshold.

The # of remaining waypoints refers to the number of waypoints that the UE has not yet passed through among the waypoints constituting the previously reported flight path, i.e., the number of waypoints remaining at the time of identifying the update conditions.

The WaypointChangeThreshold refers to the threshold value configured by base station.

As an eighth option, the UE may update the flight path when the UE passes a specific waypoint indicated by the base station among the waypoints constituting the previously reported flight path. For example, if the previously reported flight path consisted of waypoints (w1, w2, w3, w4) and the base station configured the third waypoint ‘w3’ as the flight path update point, the UE may report new flight path information to the base station when the UE passes w3.

If one or more of the above options are supported, the base station may explicitly indicate which option will be used through the RRC reconfiguration procedure. Alternatively, the base station may indirectly indicate which option to use by configuring the parameters necessary to use a specific option.

Exchange of flight paths between base stations and retransmission of flight path report messages from UEs upon UE handover.

In FIGS. 4, 5, and 6, after the UE reports the updated flight path to the serving cell through a predetermined RRC message (e.g., UEAssistanceInformation), the UE may handover to another cell. When the base stations operating the serving cell and target cell are different, the base station of the serving cell may transmit the UE's flight path information to the target cell base station through inter-base station signaling for handover preparation. However, if the time when the UE updated the flight path is immediately before the handover occurs (for example, within 1 second), the serving cell base station may be unable to deliver the UE's updated flight path information through inter-base station signaling exchanged during handover preparation. Accordingly, if the UE reported the updated flight path to the existing cell just before handover (for example, within 1 second), the UE may retransmit a predetermined RRC message including the flight path information to the new cell after handover.

Dual Connectivity Scenario:

If a master cell group (MCG) failure occurs in a dual connectivity situation, the UE may transmit a predetermined RRC message including an updated flight path to a secondary cell group (SCG) through one of split signaling radio bearer 1 (SRB1), split SRB2, and SRB3.

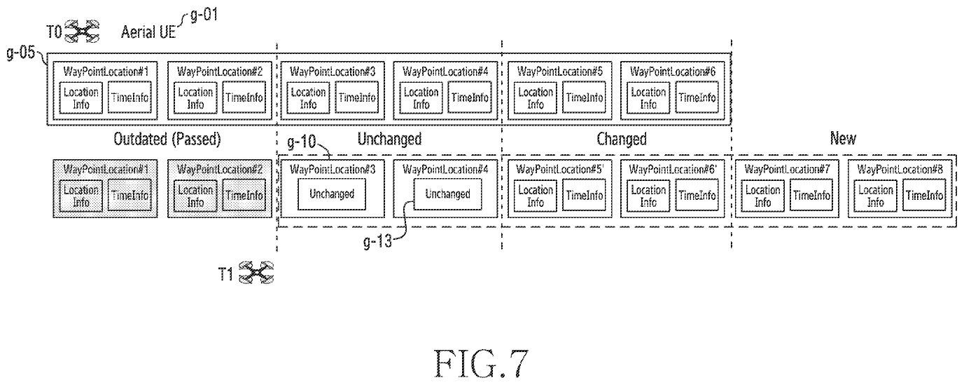

FIG. 7 illustrates a method for reporting the updated flight path of an aerial UE in a next-generation mobile communication system according to an embodiment.

The aerial UE g-01 may report the flight path g-05 to the base station at TO. In this case, a total of 6 pieces of waypoint information {W1, W2, W3, W4, W5, W6} may be included in the List. Afterwards, the aerial UE g-01 may update the flight path at T1 past the previously reported waypoint W2. In this case, steps d-70, e-45, and f-45 in FIGS. 4, 5, and 6 may correspond to the flight path update performed by the aerial UE g-01 at time T1 in FIG. 7. The following two options may be considered as a method for the aerial UE g-01 to report the updated flight path.

As a first option, the aerial UE g-01 may report a new waypoint list for flight path update regardless of the previously reported waypoint list. For example, when the base station configures the aerial UE to report up to 6 waypoints, the aerial UE g-01 may report new waypoint information {W1′, W2′, W3′, W4′, W5′, W6′} to the base station by including the new waypoint information in the list regardless of the previously reported waypoint information. When receiving a newly updated waypoint list, the base station may delete the previously reported waypoint list and save a new waypoint list.

As a second option, the aerial UE g-01 may only partially report changed waypoint information compared to the previously reported waypoint list g-05. In this case, the following update operation may be required for each of the previously reported waypoints {W1, W2, W3, W4, W5, W6}.

{W1, W2}: Since the aerial UE g-01 has already passed the corresponding waypoints, the previously reported W1 and W2 become unnecessary and may be deleted. For this purpose, the aerial UE g-01 may report the updated waypoint list g-10 and also indicate the number of waypoints to be deleted (2 in FIG. 7) from before the existing waypoint list g-05. When receiving the new waypoint list {W3, W4, W5′, W6′, W7, W8} along with the number of waypoints to be deleted, the base station may determine that the remaining {W3, W4, W5, W6} previously reported corresponds to the front part {W3, W4, W5′, WC} of the newly reported list (g-10) after releasing W1 and W2 among the previously reported waypoints {W1, W2, W3, W4, W5, W6} g-05.

Although an index is assigned to each waypoint for ease of explanation, a separate index may not be assigned to each waypoint in actual signaling. In this case, because the correspondence between the previously reported waypoint list g-05 and the newly reported waypoint list g-10 must be identified through the order of the waypoints located in the list, when updating the flight path, if there is information that needs to be released among the existing waypoints, the aerial UE g-01 must indicate the number of waypoints to be deleted from the existing list so that the base station may identify the correct correspondence between the waypoints included in the existing list and the new list. A method may be to include an index indicator for each waypoint in WayPointLocation IE additionally, but in this case, additional signaling load may occur for index management (e.g., index reset, etc.) because the index must continue to increase over time.

{W3, W4}: When there is no change in the previously reported waypoint information, the aerial UE g-01 may only include a 1-bit indicator (e.g., unchanged) g-13 to indicate that there is no change in the waypoint {W3, W4} in the previously reported list g-05 without additionally reporting duplicate Location/Time information within WaypointLocation for the waypoint {W3, W4} in the updated list g-10. Through this, previously reported information may be efficiently reused without unnecessary duplicate reporting for waypoints where WayPointLocation information is not changed.

{W5′, W6′}: When there is a change in the previously reported waypoint information, the aerial UE g-01 may report including new Location/Time information in WayPointLocation information of the waypoint {W5′, W6′} that exists in the position corresponding to the previously reported {W5, W6} in the updated List g-10.

{W7, W8}: When adding a new waypoint that is not in the previously reported waypoint information, the aerial UE g-01 may report including new Location/Time information in WayPointLocation information of the waypoint {W7, W8} added in the updated List g-10.

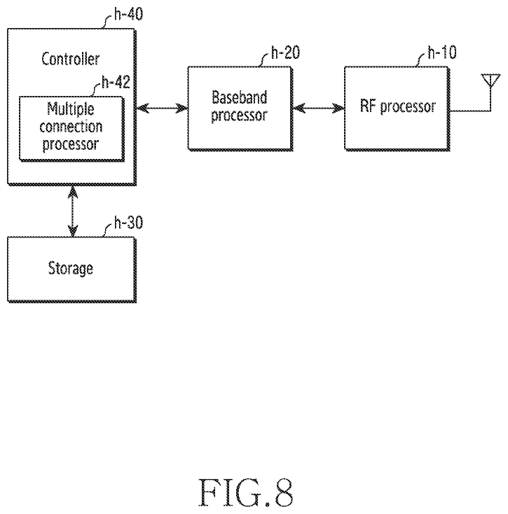

FIG. 8 is a block diagram illustrating the internal structure of a UE to which the disclosure is applied.

In FIG. 8, the UE includes a radio frequency (RF) processor h-10, a baseband processor h-20, a storage h-30, and a controller h-40.

The RF processor h-10 performs a function for transmitting and receiving a signal through a radio channel, such as band conversion and amplification of a signal. For example, the RF processor h-10 up-converts a baseband signal provided from the baseband processor h-20 into an RF band signal, transmits the RF band signal through an antenna, and down-converts the RF band signal received through the antenna to the baseband signal. The RF processor h-10 may include a transmission filter, a reception filter, an amplifier, a mixer, an oscillator, a digital to analog converter (DAC), an analog to digital converter (ADC), and the like. In FIG. 8, only one antenna is illustrated, but the UE may include a plurality of antennas. In addition, the RF processor h-10 may include a plurality of RF chains and may perform beamforming. For the beamforming, the RF processor h-10 may adjust the phase and magnitude of each of signals transmitted and received through a plurality of antennas or antenna elements. In addition, the RF processor may perform MIMO, and receive multiple layers when performing the MIMO operation.

The baseband processor h-20 performs a function of converting between a baseband signal and a bit stream according to a physical layer standard of the system. For example, when transmitting data, the baseband processor h-20 generates complex symbols by encoding and modulating a transmission bit stream. In addition, when receiving data, the baseband processor h-20 restores a reception bit stream by demodulating and decoding the baseband signal provided from the RF processor h-10. When following an OFDM scheme and transmitting data, the baseband processor h-20 generates complex symbols by encoding and modulating a transmission bit stream, maps the complex symbols to subcarriers, and then configures OFDM symbols through an inverse fast Fourier transform (IFFT) operation and cyclic prefix (CP) insertion. When receiving data, the baseband processor h-20 divides the baseband signal provided from the RF processor h-10 into OFDM symbol units, restores signals mapped to subcarriers through a fast Fourier transform (FFT) operation, and then restores a reception bit stream through demodulation and decoding.

The baseband processor h-20 and the RF processor h-10 transmit and receive signals as described above and may be referred to as a transmitter, a receiver, a transceiver, or a communicator. At least one of the baseband processor h-20 and the RF processor h-10 may include a plurality of communication modules to support a plurality of different radio access technologies and different communication modules to process signals of different frequency bands. For example, the different radio access technologies may include a wireless LAN (e.g., IEEE 802.11), a cellular network (e.g., LTE), and the like. In addition, the different frequency bands may include a super high frequency (SHF) band and an mmWave band.

The storage h-30 stores data such as a basic program, an application program, and configuration information for the operation of the UE. In particular, the storage h-30 may store information related to a second access node performing wireless communication by using the second radio access technology. In addition, the storage h-30 provides stored data according to the request of the controller h-40.

The controller h-40 controls overall operations of the UE. For example, the controller h-40 transmits and receives signals through the baseband processor h-20 and the RF processor h-10. In addition, the controller h-40 writes data in the storage h-40 and reads the data. To this end, the controller h-40 may include at least one processor. For example, the controller h-40 may include a communication processor (CP) performing controls for communication and an application processor (AP) that controls an upper layer such as an application program. The controller h-40 may further include a multiple connection processor h-42 that supports multiple connections.

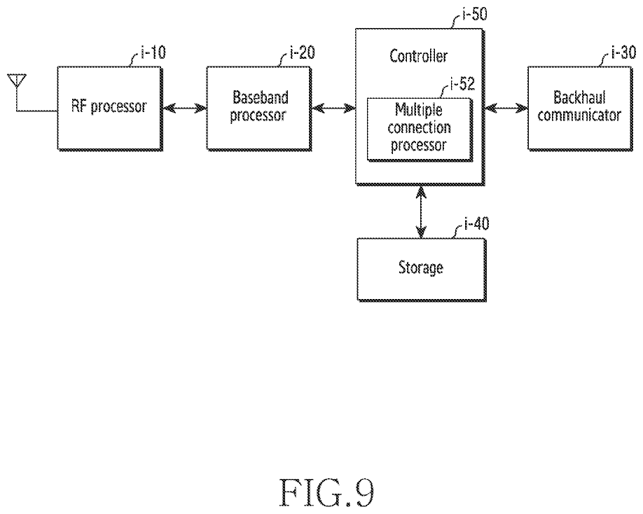

FIG. 9 is a block diagram illustrating the configuration of a base station according to an embodiment.

In FIG. 9, the base station includes an RF processor i-10, a baseband processor i-20, a backhaul communicator i-30, a storage i-40, a controller i-50, and a multiple connection processor i-52.

The RF processor i-10 performs a function for transmitting and receiving a signal through a radio channel, such as band conversion and amplification of a signal, and the like. For example, the RF processor i-10 up-converts a baseband signal provided from the baseband processor i-20 into an RF band signal, transmits the RF band signal through an antenna, and down-converts the RF band signal received through the antenna to the baseband signal. The RF processor i-10 may include a transmission filter, a reception filter, an amplifier, a mixer, an oscillator, a DAC, an ADC, etc. In FIG. 9, only one antenna is illustrated, but the first access node may include a plurality of antennas. In addition, the RF processor i-10 may include a plurality of RF chains and may perform beamforming. For the beamforming, the RF processor i-10 may adjust the phase and magnitude of each of signals transmitted and received through a plurality of antennas or antenna elements. The RF processor may perform a downlink MIMO operation by transmitting one or more layers.

The baseband processor i-20 performs a function of converting between a baseband signal and a bit stream according to a physical layer standard of the first radio access technology. For example, when transmitting data, the baseband processor i-20 generates complex symbols by encoding and modulating a transmission bit stream. When receiving data, the baseband processor i-20 restores a reception bit stream by demodulating and decoding the baseband signal provided from the RF processor i-10. For example, when following an OFDM scheme, when transmitting data, the baseband processor i-20 generates complex symbols by encoding and modulating a transmission bit stream, maps the complex symbols to subcarriers, and then configures OFDM symbols through an IFFT operation and CP insertion. When receiving data, the baseband processor i-20 divides the baseband signal provided from the RF processor i-10 into OFDM symbol units, restores signals mapped to subcarriers through a FFT operation, and then restores a reception bit stream through demodulation and decoding. The baseband processor i-20 and the RF processor i-10 transmit and receive signals as described above and may be referred to as a transmitter, a receiver, a transceiver, communicator, or a wireless communicator.

The backhaul communicator i-30 provides an interface for performing communication with other nodes in the network. That is, the backhaul communicator i-30 converts a bit stream transmitted from the main base station to another node, for example, an auxiliary base station, a core network, or the like, into a physical signal, and converts a physical signal received from the other node into a bit stream.

The storage i-40 stores data such as a basic program, an application program, configuration information, and the like for the operation of the base station. In particular, the storage i-40 may store information on the bearer allocated to the accessed UE, measurement results reported from the accessed UE, etc., and may store information that serves as a criterion for determining whether to provide multiple accesses to the UE or to suspend the multiple accesses. In addition, the storage i-40 provides stored data according to the request of the controller i-50.

The controller i-50 controls overall operations of the base station. For example, the controller i-50 transmits and receives signals through the baseband processor i-20 and the RF processor i-10, or through the backhaul communicator i-30. In addition, the controller i-50 writes data in the storage i-40 and reads the data. To this end, the controller i-50 may include at least one processor. The controller i-50 may further include the multiple connection processor i-52 that supports multiple connections.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to embodiments of the disclosure.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. A plurality of such memories may be included in the electronic device.

In addition, the programs may be stored in an attachable storage device which may access the electronic device through communication networks such as the Internet, Intranet, local area network (LAN), wide LAN (WLAN), and storage area network (SAN) or a combination thereof. Such a storage device may access the electronic device via an external port. A separate storage device on the communication network may access a portable electronic device.

It will be understood that each block of the process flowchart illustrations and combinations of the flowchart illustrations may be executed by computer program instructions. Since these computer program instructions may be mounted on a processor of a general purpose computer, a special purpose computer or other programmable data processing apparatus, the instructions executed by the processor of the computer or other programmable data processing equipment may generate means for executing functions described in the flowchart block(s). Since these computer program instructions may also be stored in a computer-usable or computer-readable memory which may direct a computer or other programmable data processing equipment to function in a particular manner, the instructions stored in the computer-usable or computer-readable memory may produce a manufacture article including instruction means which implement the function described in the flowchart block(s). Since the computer program instructions may also be loaded on a computer or other programmable data processing equipment, a series of operational steps may be performed on the computer or other programmable data processing equipment to produce a computer-executed process, and thus the instructions performing the computer or other programmable data processing equipment may provide steps for executing the functions described in the flowchart block(s).

In addition, each block may represent a portion of a module, a segment or code which includes one or more executable instructions for implementing a specified logical function(s). Also, it should be noted that the functions mentioned in the blocks may occur out of order in some alternative implementations. For example, two blocks shown in succession may in fact be executed substantially concurrently or the blocks may sometimes be executed in the reverse order depending on corresponding functionality.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by a terminal in a wireless communication system, the method comprising:
transmitting, to a base station, a first message including first information indicating an update of flight path information;
receiving, from the base station, a second message requesting a flight path report, the second message including second information configuring at least one of a number of waypoints for the flight path report, a distance parameter for the flight path report, or a time parameter for the flight path report;
generating the flight path report based on the second information; and
transmitting, to the base station, a third message including the flight path report.

2. The method of claim 1,
wherein the distance parameter includes at least one of a distance granularity for the flight path report, or a distance range for the flight path report, and
wherein the time parameter includes at least one of a time interval for the flight path report.

3. The method of claim 1,
wherein the first information is generated based on an identification on a number of remaining waypoints being equal to a flight path update threshold, or identification on the terminal passing a specific waypoint among the configured waypoints.

4. The method of claim 1,
wherein the flight path report includes third information on at least one of a first waypoint which is released from a last report, a second waypoint which is unchanged from the last report, a third waypoint which is changed from the last report, or a fourth waypoint which is added to the last report.

5. The method of claim 1,
wherein the first information is generated based on at least one parameter for a flight path update condition check which is received from the base station, and
wherein the flight path update condition check is performed for a waypoint subset based on at least one of a waypoint order, a waypoint location range, or a waypoint identifier.

6. A method performed by a base station in a wireless communication system, the method comprising:
receiving, from a terminal, a first message including first information indicating an update of flight path information;
transmitting, to the terminal, a second message requesting a flight path report, the second message including second information configuring at least one of a number of waypoints for the flight path report, a distance parameter for the flight path report, or a time parameter for the flight path report; and
receiving, from the terminal, a third message including the flight path report based on the second information.

7. The method of claim 6,
wherein the distance parameter includes at least one of a distance granularity for the flight path report, or a distance range for the flight path report, and
wherein the time parameter includes at least one of a time interval for the flight path report.

8. The method of claim 6,
wherein the first information is received based on a number of remaining waypoints being equal to a flight path update threshold, or identification on the terminal passing a specific waypoint among the configured waypoints.

9. The method of claim 6,
wherein the flight path report includes third information on at least one of a first waypoint which is released from a last report, a second waypoint which is unchanged from the last report, a third waypoint which is changed from the last report, or a fourth waypoint which is added to the last report.

10. The method of claim 6,
wherein the first information is received based on at least one parameter for a flight path update condition check which is transmitted to the terminal, and
wherein the flight path update condition check is for a waypoint subset based on at least one of a waypoint order, a waypoint location range, or a waypoint identifier.

11. A terminal in a wireless communication system, the terminal comprising:
a transceiver; and
a controller coupled with the transceiver and configured to:
transmit, to a base station, a first message including first information indicating an update of flight path information,
receive, from the base station, a second message requesting a flight path report, the second message including second information configuring at least one of a number of waypoints for the flight path report, a distance parameter for the flight path report, or a time parameter for the flight path report,
generate the flight path report based on the second information, and
transmit, to the base station, a third message including the flight path report.

12. The terminal of claim 11,
wherein the distance parameter includes at least one of a distance granularity for the flight path report, or a distance range for the flight path report, and
wherein the time parameter includes at least one of a time interval for the flight path report.

13. The terminal of claim 11,
wherein the first information is generated based on an identification on a number of remaining waypoints being equal to a flight path update threshold, or identification on the terminal passing a specific waypoint among the configured waypoints.

14. The terminal of claim 11,
wherein the flight path report includes third information on at least one of a first waypoint which is released from a last report, a second waypoint which is unchanged from the last report, a third waypoint which is changed from the last report, or a fourth waypoint which is added to the last report.

15. The terminal of claim 11,
wherein the first information is generated based on at least one parameter for a flight path update condition check which is received from the base station, and
wherein the flight path update condition check is performed for a waypoint subset based on at least one of a waypoint order, a waypoint location range, or a waypoint identifier.

16. A base station in a wireless communication system, the base station comprising:
a transceiver; and
a controller coupled with the transceiver and configured to:
receive, from a terminal, a first message including first information indicating an update of flight path information,
transmit, to the terminal, a second message requesting a flight path report, the second message including second information configuring at least one of a number of waypoints for the flight path report, a distance parameter for the flight path report, or a time parameter for the flight path report, and
receive, from the terminal, a third message including the flight path report based on the second information.

17. The base station of claim 16,
wherein the distance parameter includes at least one of a distance granularity for the flight path report, or a distance range for the flight path report, and
wherein the time parameter includes at least one of a time interval for the flight path report.

18. The base station of claim 16,
wherein the first information is received based on a number of remaining waypoints being equal to a flight path update threshold, or identification on the terminal passing a specific waypoint among the configured waypoints.

19. The base station of claim 16,
wherein the flight path report includes third information on at least one of a first waypoint which is released from a last report, a second waypoint which is unchanged from the last report, a third waypoint which is changed from the last report, or a fourth waypoint which is added to the last report.

20. The base station of claim 16,
wherein the first information is received based on at least one parameter for a flight path update condition check which is transmitted to the terminal, and
wherein the flight path update condition check is for a waypoint subset based on at least one of a waypoint order, a waypoint location range, or a waypoint identifier.
